(19) United States
(12) Patent Application Publication
(10) Pub. No.: US 2021/0133172 A1
(43) Pub. Date: May 6, 2021

(54) NOVEL, HIERARCHICAL AND SEMANTIC KNOWLEDGE STORAGE AND QUERY SOLUTION BASED ON INVERTED INDEXES

(71) Applicant: OntoChem, GmbH, Halle (saale) (DE)

(72) Inventors: Timo Böhme, Markkleeberg (DE); Matthias Irmer, Leipzig (DE); Claudia Bobach, Halle (DE); Lutz Weber, Stuttgart (DE)

(21) Appl. No.: 17/072,366

(22) Filed: Oct. 16, 2020

(30) Foreign Application Priority Data
Oct. 16, 2019 (EP) 19 203 635

(51) Int. Cl. G06F 16/22; G06F 9/54; G06F 16/2453

(52) U.S. Cl. CPC G06F 16/2228; G06F 40/30; G06F 16/2453; G06F 9/541

(57) ABSTRACT

The invention refers to a method of creating, storing and retrieving data sets including many complex data elements comprising the steps of receiving multiple data elements to be stored from an input data structure, providing a transformed and normalized data structure for storage into an inverted index and storage data system and providing a inverted index based search engine that allows to retrieve those data elements using hierarchical and relational data queries.

In particular, the invention refers to a method for providing an interface to an inverted index and storage by creating algorithmically a logical index schema and view from the structure of the received data elements, including hierarchical and other relational information.

Moreover, the present invention also refers to a method for searching those hierarchical and relational searching data structures.

This application claims benefit of priority to EPO provisional application number EP19203635, filed 16. Oct. 2019, the content of which is incorporated herein by reference in its entirety.

The present invention relates to a software method to implement a scalable, inverted document index (J Zobel, A Moffat, 2006, “Inverted Files for Text Search Engines”. ACM Computing Surveys. New York: Association for Computing Machinery. 38, 6) based system to efficiently store, manage, and retrieve both unstructured and structured data such as complex datasets and data relationships. These complex data sets may for example utilize very large hierarchical taxonomies or ontologies that are combined with such complex data, for example as value properties in the form of recursive attribute-value pairs. Herein, we call these data structures “extended facts relations” (XFR) and the general technology using the methods according to the present invention “extended facts database” or xfactDB that implements these extended fact relations as hierarchical fields (extended facts relation field, XFRF) of a logical view on top the fields of an inverted index.

A range of different database technologies has been developed to efficiently perform storage and retrieval tasks more or less efficiently for specific use cases. Thus, row-based relational databases have traditionally been used to store data sets which have a rather repetitive and defined explicit data structure, typically also known as database schema. The more complex the data, the more complex and interconnected relational database tables are needed to model such data. Graph, noSQL or object oriented databases are designed to alleviate some of the disadvantages of relational databases, but have their own limitations—thus the answer to the question which technology to use will depend on the internal structure of the data and the respective use case. Thus, recommendations are available to select database technologies based on the respective granular requirements (M. Färber and A. Rettinger, “Which Knowledge Graph Is Best for Me?”, https://arxiv.org/pdf/1809.11099.pdf, 28. Sep. 2018). However, graph databases also require that the user develops a suitable data model for the data to be stored which can be a time consuming task. Graph databases typically may enable to read, store and retrieve RDF subject-predicate-object triples. Such retrieval may include the fast traversal of a full graph of related data triples—showing a clear efficiency benefit over complex relational table joins.

Other database technologies include for example column oriented database management systems like Bigtable, Hbase or Hypertable (https://en.wikipedia.org/wiki/Column-oriented DBMS). These are of interest as they can be easily distributed and may more efficiently deliver answers than row based systems.

In our work to extract, normalize, store and retrieve structured data from both structured and unstructured data sources such as patents, scientific articles as well as databases we observed that both relational databases as well as object oriented databases may not be ideal in terms of storage efficiency, search performance or ease of use for such complex datasets.

Some examples of such complex data—or extended fact relations—according to the present invention are typically data collections with a large number of smaller datasets that each do exhibit an internal hierarchical and/or relational structure, for example:
chemical process and reaction data with several reaction participants having specific optional properties, process roles and being subject to certain structured manipulations
physico-chemical properties of materials or compositions of materials
genomic data like next generation sequencing results for all humans
data on businesses that include all relationships to employees or suppliers

Please see our Examples 1-9 for more details.

The aim of the present invention is to implement an efficient, ontology based storage and retrieval technology that allows to include hierarchical and relational query concepts when retrieving the data from the system.

Hierarchical in the context of the present method shall mean that extended fact relation fields (XFRF) are attached to and do only exist if a parent data element is present.

Relational in the context of the present method shall mean that the XFRF data fields are composed into a relational data structure that reflects the structure of a given input dataset.

Each XFRF may be connected to a taxonomy or ontology that defines its semantic context. For the definition of taxonomy we refer to “a system for naming and organizing things, especially plants and animals, into groups that share similar qualities” https://dictionary.cambridge.org/dictionary/english/taxonomy using a generalized “is a” relationship between those elements of the taxonomy. For a definition of ontology we refer to https://en.wikipedia.org/wiki/Ontology (information science) where an ontology encompasses a representation, formal naming and definition of the categories, properties and relations between the concepts, data and entities that substantiate one, many or all domains of discourse, where the number of different relationship types between the elements (or concepts or nodes) of an ontology is not limited. For the sake of clarity, both the taxonomy or ontology must not be part of the XFR or xfactDB but will reside outside as an independent data structure. However, each XFRF has its taxonomy or ontology ancestor information included in the inverted index to speed-up semantic look-up operations. On the other hand, ontologies may be also stored in an inverted document store: here, each taxonomy or ontology concept represents a “document” in the inverted index, containing all documents—or extended facts in this case—that contain such concept.

For the definition of semantic or ontology based look-up a given XFRF may be searched for as a part of a given taxonomy or ontology. Thus, for example, since a “peach tree” is a “tree”, which is a “plant”, which is a “species”, a semantic query will retrieve all XFR records that contain the ancestor concept “peach tree” when querying with an upper concept “plant”.

The present invention combines some advantageous features of a relational database with some advantages of graph or object databases. For example, it allows graph based searching over named entities (in an XFRF) that occur in extended facts relations (XFR).

On the other hand, the method according to the present invention extends typical RDF subject-predicate-object triple data records of graph databases by allowing to use extended facts in the form of complex N-tuple relationship records, according to the present definition XFR. In addition, as a specific advantage, no specific database schema has to be developed, it is rather defined algorithmically by the interface module that reads the input and recognizes its structure.

Different to RDF triple records as used for graph databases, each XFRF element of such extended fact relation may comprise one or multiple terms, texts or concepts, numeric values or value ranges and an associated unit together with additional textual data. This method removes a major disadvantage of graph databases, where complex N-tuples have to be split into all possible triples requiring to carefully develop complex data schemata and additional preparation steps—which is time consuming and will also impair the search speed when querying such complex data. Also, splitting N-tuples into all related triples increases considerably the memory or storage media size and thus the associated costs of a technology product solution. The method according to the present invention permits the storage of recursive attribute-value structures of arbitrary complexity in a straightforward and intuitive way.

Each field of a given extended fact relation may itself be part of a hierarchy naming space of that record that can be utilized by suitable queries. Field elements are connected to taxonomies or ontologies allowing to retrieve these N-tuple relationships by semantic queries.

Finally, xfactDB is not only used as a store but also as a semantic search engine providing an interface and logical views on the stored data using the inverted index that will respond to queries via a typical RESTful application programming interface.

Thus, the modules that are needed for the methods according to the present invention are
an input interface to xfactDB to read hierarchical and relational data sets, for example in comma, tabulator or other character delimited text files, Excel files, JavaScript Object Notation (JSON), or Resource Description Framework (RDF) format using TTL, NT, XML or other suitable formats and converting this input into xfactDB hierarchical storage data according to the methods described in this invention.
an algorithm to automatically create the inverted document indexes that define the indexing procedures and data types of the hierarchical index fields as described in the example method implementation.
a query and output interface to xfactDB to retrieve semantic data from xfactDB. This interface will convert the natural language input into a Lucene index query.

These properties make xfactDB especially suitable for storing and retrieving scientific data points as described in Examples 1-9.

### BRIEF DESCRIPTION OF THE DRAWINGS

The above and other features of the present invention will now be described in detail with reference to exemplary embodiments thereof illustrated in the accompanying drawings which are given herein below by way of illustration only, and thus are not limitative of the present invention, and wherein:

FIG. 1 shows an exemplified extended fact relation—the hierarchical, relational data set structure;

FIG. 2 shows exemplified data elements of an extended facts relation field (XFRF);

FIG. 3 shows a translation of logical XFR field into Lucene field storage;

FIG. 4 shows storage of recursive attribute-value structures; and

FIG. 5 shows the frame structure according to the present disclosure.

### METHOD IMPLEMENTATION

The above described methods have been implemented as a backend search engine into semantic search applications. For example, SciWalker www.sciwalker.com uses an xfactDB methods based backend engine API to retrieve data such as the reaction data or material property data. In that example, xfactDB uses as native storage and indexing backend Apache Lucene (https://lucene.apache.org/) with its inverted document index. On top of Lucene, xfactDB provides two abstraction layers which map the hierarchically structured extended fact relations into extended fact relation fields and finally into the simple field semantic used by Lucene. In addition, support of numeric value and value range indexing as well as support of ontological concepts is provided. The functionality of xfactDB is exported and accessible by a RESTful API.

More specifically, xfactDB models an N-tuple relation as a set of extended fact relation fields. One such field corresponds to a, possibly enriched, element of the relation. Each structured relational field may contain the following types of data
one to many concepts (specified via their numeric ontological concept identifier—OCID)
one to many terms or alternatively a full text snippet
one to many numeric values (as float or integer) or alternatively a numeric range
a unit for the numeric values
additional data (string encoded, allowing for text or structured data, e.g. using JSON format) which is only stored with the field, i.e. can not be restricted within a query over the relational data but can be returned as part of the field data with relations matching a query

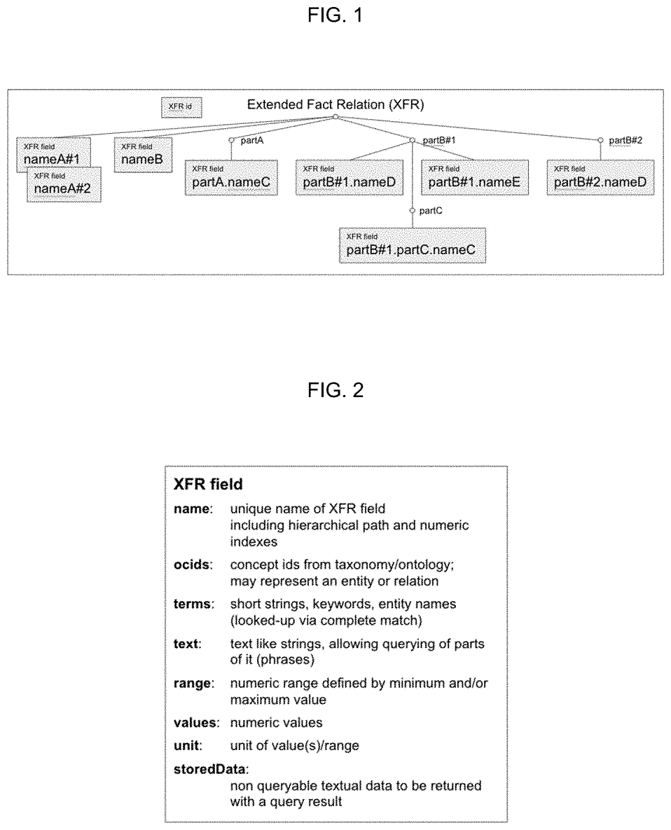

Extended fact relations (as shown in FIG. 1) to be stored in xfactDB may either contain no data for a specific relational field, only one type of data or more than one type of data—including all of the 5 types described above (e.g. a specific concept with a concept id, additional synonyms as textual terms, a numeric quantity measured for this concept in this specific relation, its associated unit and some description in the additional data). This relational field model gets translated via the Relational-to-Lucene abstraction layer (R2L) into the simple field semantic of Lucene. Each relation is added to Lucene as a Lucene document and the named relational fields are mapped to one or multiple Lucene fields each depending on the data type and possible extra defined properties like if a field should be sortable by a specific data type. The following mappings are available (relational field type to Lucene fields):
concept data
   base OCIDs
   ancestor OCIDs—using ontology information this Lucene field stores the concept OCID together with all ancestor OCIDs up to the ontology root (for a hierarchical ontological relationship like an is-a one)
   sort field—using ontology information the preferred name of the first concept is added here in case the relational-field should be sortable by concept data type
   concept+terms sort field—in case relational-field may contain both concepts and terms this field allows for sorting concepts and terms combined
   aggregation field—supports summary information about the concepts and their occurrence of matching relations for this field (using Lucene facets support)
terms
   exact-terms—stores Unicode-normalized exact terms in index for lookup of identical strings like identifier, chemical names etc.
   normalized-terms—stores terms Unicode normalized, case-folded and with other folding operations applied in order to allow for case-insensitive and character normalized lookups
   sort field—holds first terms normalized for sorting
   aggregation field—supports summary information about the terms and their occurrence of matching relations for this field (using Lucene facets support)
text
   exact-text—stores full text tokenized, Unicode normalized and folded like done for normalized-terms, allowing e.g. for phrase searches and not only full terms
   stemmed-text—additional to the tokenization and normalization done for exact-text it does morphological stemming on the text token allowing for broader searches
values
   integer values—stores integer type numeric values
   float values—stores float type numeric values
   range-min-integer—stores integer type minimum numeric range value
   range-max-integer—stores integer type maximum numeric range value
   range-min-float—stores float type minimum numeric range value
   range-max-float—stores float type maximum numeric range value
   sort-min-integer—minimum value for sorting of integer type
   sort-max-integer—maximum value for sorting of integer type
   sort-min-float—minimum value for sorting of float type
   sort-max-float—maximum value for sorting of float type
unit
   unit—exact match field
stored-data
   store-only field

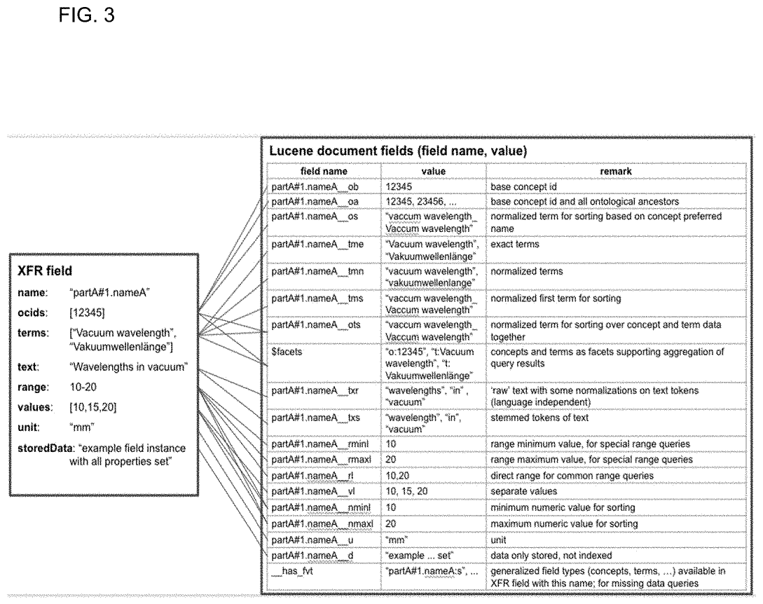

FIG. 2 illustrates exemplified data elements of an extended facts relation field (XFRF). In addition, each relation gets a unique numeric id that enables one to identify a specific relation within xfactDB. In order to allow for queries targeting the flexible relational schema, e.g. requiring certain relational fields and specific data types or selecting ones which do not contain certain fields, the relational fields with their data types used in a relation are also indexed in an extra/internal Lucene field, as shown in FIG. 3.

The naming of the relational fields can be done in a hierarchical way allowing to build a name from connected components like ‘reaction.start-material.name’ (components ‘reaction’, ‘start-material’ and ‘name’). In addition, components may get an index to support collections of fields with the ability to query all together or to name a specific one. For this, the component may be appended by ‘#NUMBER’, e.g. ‘reaction.start-material#1.name’ and ‘reaction.start-material#2.name’. Thus, querying these hierarchical representations can be regarded like browsing a folder structure, where prefixes define the hierarchy of the data elements.

In order to leverage the hierarchical and collection naming of the relational-fields within a query, a naming-resolving (NR) layer is used which translates the user query containing wildcards and query internal references utilizing the hierarchical naming into a query containing the resolved relational field names. Depending on the relational field schema and the references/wildcards used in the query this may result in a quite complex query which is automatically created—a step which in generic graph databases would require manual intensive work.

When creating an xfactDB, a schema may optionally be defined allowing to fine-tune the storage aspects of the individual relational fields like supported data types, numeric type, sorting and aggregation requirements. However this is not required, and also only a partly defined schema is possible. All not specified relational fields will support the maximum possible data functionality. Thus in contrast to relational databases no schema needs to be defined beforehand and the schema can be enlarged at any time without changes to existing data. On the other hand providing a schema can be used to optimize resource consumption.

As numeric data-points, values and ranges are especially important for scientific data. The design of xfactDB was optimized to handle this kind of data with greatest flexibility. Each relational field may contain numeric data as single value(s) or range and the query API as well allows to search for values or ranges. The same value-query can be used against value and range data and also a range-query can be run against values or ranges in a relational-field. The R2L layer will map the query according to the relation-field schema in the xfactDB. It also allows and maps for 9 kinds of how a range can be matched against another range.

According to the present invention, the inverted index field types and indexing rules shown in the images are defined by simple, predefined algorithms that convert the input data and fill the inverted index. For example, data belonging together, like N-tuple data, are converted into a hierarchy as defined in the input hierarchy, text fields will become indexed as text, identifiers as long integers or alike as explained above.

Characteristics of xfactDB Implementation Example:
Ultrafast, semantic and hierarchical searching of concepts in complex data relationships
Storing complex relationship data like in a table—by combining concepts with factual data and multiple hierarchical relationships
Expands a triple store to a store of complex “extended fact relations”
Each extended fact relation may represent more than conventional 100 triples
Allows to describe complex scientific relationships in a straightforward way
Reduces time for labor intensive data modelling
Records may contain up to thousands of different elements
Needs less expensive hardware resources than comparable content graph databases
Builds on and is integrated into standard reverse index document solutions such as for example Lucene
Single xfactDB instance with up to 2 billion extended fact relations on standard hardware
One virtual xfactDB instance by grouping multiple xfactDB instances to go beyond 2 billion records.

Efficiency considerations: we have compared the performance of a semantic query in xfactDB by loading and querying the same data into the column based Bigtable. While xfactDB was implemented on a standard 32 core, 32 GB RAM linux based hardware, for Bigtable we used Google's out of the box BigQuery technology. Thus, 2 seconds were needed to retrieve all reactions from 2 million possible reactions that contained the drug benazepril both on BigQuery as well as on xfactDB using the chemical structure of benazepril. When more complex ontology data is used, xfactDB outperformed a standard BigQuery—for example searching for reactions that contain a compound with a substructure of 1,8-naphthyridine takes 18, versus 28 seconds.

### Example 1: Hierarchical Data Structure for Storing Process Information

<manufacturing process>

< <step 1>

< <mixing><CaO><K2CO3><SiO2> >

>
< <step 2>

< <heating>

< <start at 21 °C><end at 800 °C>><4 h> >

>

>
< <step 3>

< <extrusion><extruder m540><2 mm> >

>
< <step 4>

< <cooling>

< <start at 750 °C><end at 30 °C>><2 h> >

>

>

### Example 2: Hierarchical Data Structure for Storing Complex Material Properties

<ytterbium-phosphate glass>

< <composition><containing><P2O5: 60-75 mole%><Yb2O3:10-30 mole%> >...

< <property>
< <viscosity><equals><8 Poise><800 °C> >

>

### Example 3: Hierarchical Data Structure for Storing Chemical Reactions Like a 2-Step Synthesis Procedure

<chemical reaction>

< <product> <cis-3-(4-fluorophenyl)-N-(2-methoxyethyl)-2-[(4-

methylphenyl)methyl]-1-oxo-3,4-dihydroisoquinoline-4-carboxamide>

< <melting point> <154-156 °C> >

< <white crystals> >
< <yield><72%> >

>

>
< <step 1>

< <starting material> <homophthalic acid> <p-fluoro-benzaldehyde>
<4-methyl-benzylamine>
>
< <catalyst > <BF3*OEt2> >
< <solvent> <Et2O> >

>
< <step 2>

< <starting material> <methoxy-ethyl-amine> >
< <solvent> <DMF> >
< <catalyst><DCC> >

>

### Example 4

Hierarchical Data Structure for Storing Chemical Reaction Data in Reaction Smiles (RSMI) format—derived from Simplified Molecular Input Line Entry Specification (SMILES), comprising starting materials, reagents and products. This example describes the participants of a hydrogenation reaction in ethanol:

[I−].[N+](═O)([O−])C1=C(C═CC2=[N+](C═CC═C2)C)C═CC═C1>[Pt]═O.C(C)O>NC1=C(CCC2N(CCCC2)C)C═CC═C1

### Example 5

Hierarchical data structure for storing a chemical reaction as from example 4 and additional data in JSON format, comprising starting materials, reagents and products but also reaction conditions, yields and unique identifiers:

{

“fields”: {

“rel”: { “ocids”: [ 232000000002 ], “storedData”: “[chemical reaction]” },
“product”: {

“ocids”: [ 190000907598 ], “storedData”: “NC1=C(CCC2N(CCCC2)C)C=CC=C1”,
“terms”: [ “2-[2-(1-methylpiperidin-2-yl)ethyl]aniline” ] },

“reactant#0”: {

“ocids”: [ 190000037986 ], storedData”: “[I-]”,
“terms”: [ “iodide” ] },

“reactant#1”: {

“ocids”: [ 190001688778 ], “storedData”: “[N+](=O)([O-])C1=C(C=CC2=[N+](C=CC=C2)C)C=CC=C1”,
“terms”: [ “1-methyl-2-[2-(2-nitrophenyl)ethenyl]pyridin-1-ium” ] },

“reagent#0”: {

“ocids”: [ 190005816176 ], “storedData”: “[Pt]=O”,
“terms”: [ “oxoplatinum” ] },

“reagent#1”: {

“ocids”: [ 190000014300 ], “storedData”: “C(C)O”,
“terms”: [ “ethanol” ] },

“rinchi”: {

“storedData”: “RInChI=1.00.1S/C14H13N2O2.HI/c1-15-11-5-4-7-13(15)10-9-12-6-2-3-8-

14(12)16(17)18;/h2-11H,1H3;1H/q+1;/p-1<>C14H22N2/c1-16-11-5-4-7-13(16)10-9-12-6-2-3-8-14(12)15/h2-
3,6,8,13H,4-5,7,9-11,15H2,1H3<>C2H6O/c1-2-3/h3H,2H2,1H3!O.Pt/d+” },

“rinchikey”: {

“text”: “Web-RInChIKey=CIGCEUXGTWQAJHRZC-MUHFFFADPSCTJSA” },

“rsmi”: {

“storedData”:

“[I-].[N+](=O)([O-])C1=C(C=CC2=[N+](C=CC=C2)C)C=CC=C1>[Pt]=O.C(C)O>NC1=C(CCC2N(CCCC2)C)C=CC=Cl” },

“source_context”: {

“storedData”: “A suspension of 2-(o-nitrostyryl)-1-methylpyridinium iodide (40.5 mg., 0.11 mole) prepared

according to the method of L. Horwitz, J. Org. Chem., 21, 1039 (1956) in 200 ml. of ethanol is hydrogenated in a
Parr hydrogenation apparatus employing 0.3 g. of platinum oxide catalyst while maintaining a reaction
temperature of from about 50° to 75°C. When the hydrogen uptake ceases (about 3 hours), the reduction
mixture is filtered, the filtrate evaporated and the resulting residue taken up in 500 ml. of water. The aqueous
solution is basified with 40% sodium hydroxide and extracted with several 200 ml. portions of ether. Ethereal
extracts are combined, washed with water, dried over magnesium sulfate, and the ether evaporated.
Distillation of the residue thus obtained provides 20.8 g. (87% yield) of 2-(o-aminophenethyl)-1-
methylpiperidine base having a boiling point of 121°-125°C. at 0.04 mm.” },

“source_id”: {“text”: “US-03931195-A” },
“source_section”: {“text”: “description” },
“srcrep”: {“terms”: [ “patents” ] },
“yield”: {

“ocids”: [ 236000002125 ],
“terms”: [ “yield” ],
“unit”: “237000000065”,
“values”: [ 87 ] }

},
“relationId”: 194

}

### Example 6: Hierarchical JSON Format Data Structure for Storing Genetic Polymorphism Data

{

“fields”: {

“rel”: { “ocids”: [ 232000000800 ] },
“doc_id”: { “storedData”: “9398160” },
“gene_variant”: {

“ocids”: [ 102200066921 ],
“terms”: [ “mutations” ] },

“protein”: {

“ocids”: [ 102100014144, 102100001834 ],
“terms”: [ “SEC23A”, “SEC24D mutations” ] },

“target”: {

“ocids”: [ 208000004523 ],
“terms”: [ “cranio-lenticulo-sutural dysplasia” ] },

“source_date”: { “storedData”: “2015-01-01” },
“source_id”: { “storedData”: “9398160” },
“source_link”: {

“storedData”: “https://projectreporter.nih.gov/project_info_description.cfm?aid=9398160” },

“srcrep”: { “terms”: [ “pm_nihgrants” ] },
“srcsent”: {

“storedData”: “PUBLIC HEALTH RELEVANCE: We have identified SEC23A and SEC24D mutations linked to

cranio-lenticulo-sutural dysplasia.” }

},
“relationId”: 1428584

}

### Example 7: Hierarchical JSON Format Data Structure for Storing Disease Biomarker Data

{

“fields”: {

“rel”: { “ocids”: [ 232000000676 ] },
“biomarker”: {

“ocids”: [ 102100009641 ],
“terms”: [ “IP-10” ] },

“biomarker_target”: {

“ocids”: [ 208000005721 ],
“terms”: [ “HIV disease progression” ] },

“type”: {

“ocids”: [ 400500000232 ],
“terms”: [ “good biomarker” ] },

“doc_id”: { “storedData”: “1757999” },
“source_date”: { “storedData”: “2017-09-11” },
“source_id”: { “storedData”: “PMC5601991” },
“source_link”: { “storedData”: “http://www.ncbi.nlm.nih.gov/pmc/articles/PMC5601991” },
“srcrep”: { “terms”: [ “PubMed Central”, “pmc” ] },
“srcsent”: {

“storedData”: “The correlation between IP-10 and disease progression confirmed that IP-10 is a good

biomarker in HIV disease progression.” }

},
“relationId”: 635336

}

### Example 8

The xfactDB permits the storage of recursive attribute-value structures of arbitrary complexity in a straightforward and intuitive way.

In general, a fact according to the present method is represented by a set of attributes of which each is filled by some value. A value is either a simple or a complex fact itself which in turn consists of a number of attributes filled by values. Such a recursive attribute-value structure is known as a conceptual frame (Barsalou, L. W. (1992). Frames, concepts, and conceptual fields. In E. Kittay & A. Lehrer (Eds.), Frames, fields, and contrasts: New essays in semantic and lexical organization (pp. 21-74). Hillsdale, N.J.: Lawrence Erlbaum Associates.). Such a conceptual frame has the general structure depicted below, where fx represents a fact, ax stands for an attribute and vx for a value (with x=1 . . . n). While v1 and v2 are simple values for attributes a1 and a2, respectively, attribute a3 is filled by a complex value v3 which itself is a fact f2 consisting of attributes a31 and a32 which are filled by values v31 and v32. In this way, arbitrary complex recursive attribute-value structures can be constructed. In xfactDB, such a structure is modeled in a straightforward manner as a single relational entry, where attributes correspond to field names, simple values to fields, and complex values are represented as a set of fields with field names composed by the names of those attributes which lie on the path from the root fact to each simple value contributing to the complex value.

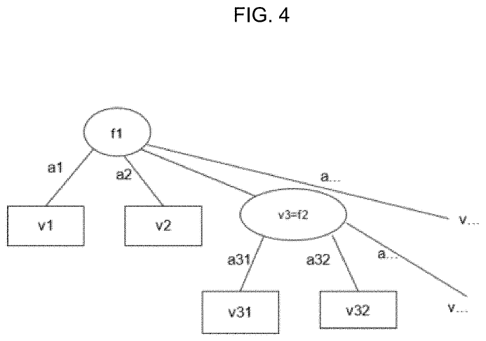

To illustrate such a structure (shown in FIG. 4), consider the following excerpt from a materials science patent (US-20180323425-A1) describing a complex multi-layer compound material:
“The present invention relates to a negative electrode active material including a secondary particle in which primary particles are aggregated, wherein the primary particle includes: a core including one or more of silicon and a silicon compound; and a surface layer which is disposed on a surface of the core and contains carbon, wherein an average particle size D50 of the core is in a range of 0.5 μm to 20 μm.”

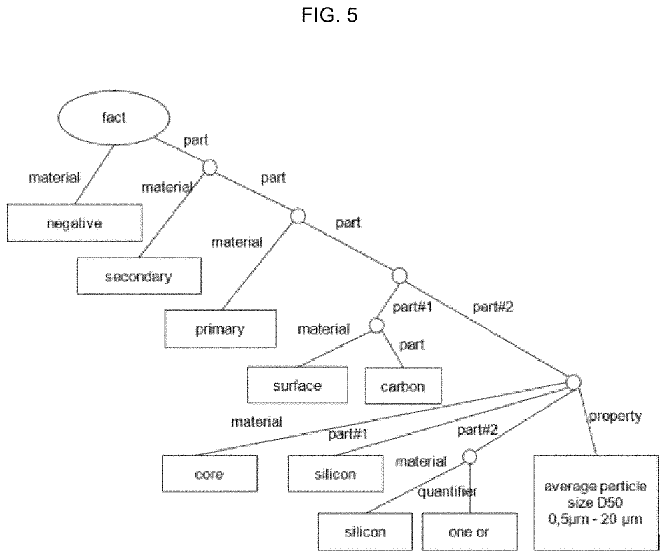

This sentence describes a complex material which consists of a nested structure of materials, their parts, possibly specified by quantifiers, and their properties, specified by ranges of values in some unit. The structure of this material can be captured by the frame structure depicted in FIG. 5.

In xfactDB, this structure can be stored by the following relational entry in hierarchical JSON format:

{

“fields”: {

“doc_id”: { “values”: [ 340 ] },
“fact.material”: { “ocids”: [ 239000007773 ], “terms”: [ “negative electrode active material” ] },
“fact.part.material”: { “ocids”: [ 239000011163 ], “terms”: [ “secondary particle” ] },
“fact.part.part.material”: { “ocids”: [ 239000011164 ], “terms”: [ “primary particle” ] },
“fact.part.part.part#1.material”: { “ocids”: [ 239000002344 ], “terms”: [ “surface layer” ] },
“fact.part.part.part#1.part”: { “ocids”: [ 229910052799 ], “terms”: [ “carbon” ] },
“fact.part.part.part#2.material”: { “ocids”: [ 239000011162 ], “terms”: [ “core” ] },
“fact.part.part.part#2.part#1”: { “ocids”: [ 150000003377 ], “terms”: [ “silicon compound” ] },
“fact.part.part.part#2.part#2.material”: { “ocids”: [ 229910052710 ], “terms”: [ “silicon” ] },
“fact.part.part.part#2.part#2.quantifier”: { “ocids”: [ 237100000165, 237100000124 ],

“terms”: [ “one”, “more” ] },

“fact.part.part.part#2.property”: {

“ocids”: [ 236000001222 ],
“rangeMax”: 2e−05,
“rangeMin”: 5e−07,
“terms”: [ “average particle size D50” ],
“unit”: “237000000024” },

“rel”: { “ocids”: [ 232000000002 ], “storedData”: “[material_2]” },
“source_date”: { “storedData”: “2018-11-08” },
“source_id”: { “storedData”: “US-20180323425-A1” },
“source_link”: { “storedData”: “US-20180323425-A1.xml” },
“srcsection”: { “terms”: [ “abstract” ], “values”: [ 2 ] },
“srcsent”: { “storedData”: “The present invention relates to a negative electrode active material including a

secondary particle in which primary particles are aggregated, wherein the primary particle includes: a core
including one or more of silicon and a silicon compound; and a surface layer which is disposed on a surface of
the core and contains carbon, wherein an average particle size D50 of the core is in a range of 0.5 μm to 20 μm,
a method of preparing the same, an electrode including the same, and a lithium secondary battery including
the same.” }

},
“relationId”: 148219

}

### Example 9: Data Model Complexity Considerations

If multiple complex structures similar to the one shown in Example 8, but different in their hierarchical composition of nested materials, parts and/or properties, are to be stored in a single xfactDB, then the data model needs to cover the data variability for different complex materials and their parts, as well as amounts of parts, properties of materials at each hierarchical level, and possibly related processes. The dependencies of each part to its upper level and of each property to its material or part at each level have also to be covered. This happens via a so-called “role” that is realized and corresponds to a hierarchical field name of an extended fact.

### Example 9a

The simplest case of a materials data model is for example:

“fact.material”: {“ocids”:[239000006183],“terms”:[“anode active material”]}
“fact.property”:

{“ocids”:[236000002426],“terms”:[“amount”],“values”:[100],“unit”:“237005038827”}

It describes a material, in this case an anode active material, with a property, in this case its amount. The anode active material (which might be replaced by any other concept) is described as a material by the role “fact.material” and the amount is described by the role “fact.property”. The dependency between material and property is given by the common occurrence within one frame anchored by the root role component “fact”. Here we have only two roles with one dependency.

### Example 9b

In another more complex example with more layers of material structuring, the number of different “roles” is increased because of more dependencies within one relation:

“fact.material.material.material”: {

“ocids”:[239000002002],“terms”:[“slurry”]}

“fact.material.material.part”: {

“ocids”:[229910052710],“terms”:[“silicon”]}

“fact.part.material”: {

“ocids”:[239000011856], “terms”: [“silicon particles”]}

“fact.part.part”: {

“ocids”:[229910052710],“terms”:[“silicon”]}

“fact.part.property”: {

“ocids”:[236000002426],
“terms”:[“amount”],
“rangeMin”:0.1,
“rangeMax”:30,
“unit”:“237000000081”}

Here we have two different material layers (slurry and silicon particles) with two different roles (“fact.material.material.material” and “fact.part.material”) and three different parts with three different roles (“fact.material.material.part”, “fact.part.material” and “fact.part.part”) and one amount of a part with role “fact.part.property”. In this structure, there are 5 different roles with 5 part-material dependencies and one amount-part dependency. Taking into account the roles of Example 9a and 9b together, we now have increased the number of possible roles to 7.

### Example 9c

Consider further the following material structure:

“fact.material”: {

“ocids”:[237200003523],
“terms”:[“negative electrode”]}

“fact.part.material.part.material”: {

“ocids”:[239000010410],
“terms”:[“layer”]}

“fact.part.material.part.part”: {

“ocids”:[239000007773],
“terms”:[“negative electrode active material”]}

“fact.part.part.material#1”: {

“ocids”:[239000002105],
“terms”:[“nanoparticle”]}

“fact.part.part.material#2.material”: {

“ocids”:[239000002245],
“terms”:[“particles”]}

“fact.part.part.material#2.part”: {

“ocids”:[229910045601],
“terms”:[“alloy”]}

“fact.part.part.part”: {

“ocids”:[229910052710,229910052718],
“terms”:[“silicon”,“tin”]}

“fact.part.part.property”: {

“ocids”:[236000001150],
“terms”:[“average particle diameter”],
“rangeMin”:5E−8,
“rangeMax”:0.000002,
“unit”:“237000000024”}

Taking into account the roles of Example 9a, 9b and 9c, we have now 14 distinct roles in total. But not every new data entry increases the number of different roles and dependencies, e.g. the role “fact.material” in Example 9c would not increase the number of different roles, because it is already included in the data model due to the upload of data of Example 9a.

### Example 9d

“fact.material”: {“ocids”:[239000007773],“terms”:[“negative active material”]}

| | |
|---|---|
| “fact.part.material.part.material”: | {“ocids”:[239000002210],“terms”:[“silicon material”]} |
| “fact.part.material.part.part”: | {“ocids”:[229910052710],“terms”:[“silicon”]} |

| | |
|---|---|
| “fact.part.part.material”: | {“ocids”:[239000003575],“terms”:[“carbon material”]} |
| “fact.part.part.part”: | {“ocids”:[229910052799],“terms”:[“carbon”]} |

The addition of the data points of Example 9d would not increase the number of possible roles (and hence query options) because all roles are already uploaded into the data model by adding the roles of Example 9a, 9b and 9c. The number of possible roles is still 14.

Hence a plateau would be reached at some point.

Query complexity and performance are independent from the data point filling (and the diversity of concepts) and from the number of data point fillings for each role.

1. An interface to an inverted document index that algorithmically defines and stores field types, indexing rules and field hierarchies of complex relational datasets.

2. A method according to claim 1, where the inverted index field types and indexing rules and field hierarchies are algorithmically defined based on the input data structures, data types, relationships and hierarchies.

3. A method according to claim 1, where the inverted index stores knowledge triples such as subject-predicate-object relationships.

4. A method according to claim 1, where the inverted index stores complex extended fact relation data, also known as knowledge N-tuples, that are composed of relational data fields containing one or more data types such as concept data, terms, text, values, and/or stored-data of any kind.

5. A method according to claim 3, where the hierarchy between the relational data fields according to claim 3, is represented by a hierarchy in the field names.

6. A method according to claim 1, where taxonomies and ontologies are loaded in addition to the input data, and connecting respective taxonomy and ontology concepts to the extended fact relations where such concept occurs using an inverted index.

7. A method according to claim 1 where the interface is able to read complex hierarchical relational data as an input to xfactDB, adding the needed hierarchy, data types and data fields, to generate a logical view layer and translation to native inverted index fields—for example from comma or tabulator or other character delimited text files, Excel files, JavaScript Object Notation (JSON), or Resource Description Framework (RDF) format using TTL, NT, XML or other suitable formats and converting this input into xfactDB hierarchical storage data as described in claim 1.

8. A method according to claim 1 where a query and output interface will retrieve relational and hierarchical data from the inverted index as of claim 1-5 that can be queried via a RESTful WebAPI by connecting data fields with a taxonomy or ontology based index.

9. A method according to claim 1 where the inverted index is used to store unit value pairs up to unit value pair ranges.

10. A method according to claim 1, where the inverted index is used to retrieve unit value pairs or unit value pair ranges.

11. A method according to claim, where the inverted index database is Lucene.

12. A method according to claim 1, where multiple instances of the inverted index database are used to expand the number or performance of the query index.
